(19) United States
(12) Patent Application Publication
(10) Pub. No.: US 2010/0097219 A1
(43) Pub. Date: Apr. 22, 2010

(54) ARTICLE WITH THEFT-DETERRING FEATURE

(76) Inventor: Sidnei Dal Gallo, Valinhos (BR)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 12/252,674

(22) Filed: Oct. 16, 2008

(51) Int. Cl. G08B 21/00

(52) U.S. Cl. 340/572.1

(57) ABSTRACT

An article formed to receive a security marker in a manner that reduces the likelihood of the security marker from being removed, either intentionally (such as to remove the article from a restricted area without authorization to do so) or inadvertently (such as by getting caught on another article). The security marker may additionally be concealed from view to further deter intentional removal of the security marker. Moreover, the security marker may be associated with the article such that it does not impact the appearance of the article to an observer, yet removal of the security marker would damage the article in a manner that is undesirable to a user of the article and/or readily noticeable by the establishment from which the article is being improperly removed.

### FIELD OF THE INVENTION

The present invention relates to an article equipped with a theft-deterring feature and an associated method of forming an article to deter theft of the article. More particularly, the present invention relates to an article and associated method of modifying the article such that the article cannot be removed from a given area without signaling unauthorized removal from the area.

### BACKGROUND OF THE INVENTION

In order to prevent unauthorized removal of an article from a given area (such as retail stores, libraries, video rental stores, etc.), it is common to affix, attach, secure, or otherwise associate a tag, label, marker, or the like (“security marker” for the sake of convenience) to or with the article to interact with an electronic article surveillance (“EAS”) security system. The security system detects the presence of the security marker as the article with which it is associated passes through a security or surveillance zone or passes by or near a security checkpoint, interrogation zone, or surveillance station, or the like. An alarm may be actuated or another action may be initiated to prevent removal of the article from the given area.

Generally, electronic article surveillance security systems have an alarm system that alerts an appropriate individual of the removal of the article from the given area. Typically, such alarm system is arranged so that it must be deactivated by only an authorized individual. Any desired type of alarm or alert system may be used with the above-described EAS security systems. For instance, the alarm may be audible (e.g., beeping or buzzing or siren) and/or visual (e.g., flashing lights). The alarm may be detectable only within a given detection area, or throughout the entire establishment. Alternatively, a silent alarm having a remote indicator (audible, visual, or vibrating) may be used, generally detectable only by a designated operator, who may be at a designated remote location. The alarm signal may be continuous or intermittent, and it may persist for a predetermined period of time before ceasing to signal or sound, or it may continue indefinitely until it is turned off or deactivated by authorized personnel. Additionally, or alternatively, the alarm may activate a gate or other escape-blocking means. The alarm may be physically within the security system or it may be detached therefrom, but connected electronically or remotely by a wired or wireless connection.

The security marker associated with the article to be maintained within a given area may take on any of a variety of sizes, shapes, and forms, depending any of a variety of factors, such as the security system in use, the type and size of the article with which it is associated, etc. For instance, the security marker may be formed with a resonant circuit that can be sensed by and interact with a radio-frequency electromagnetic field disturbance sensing electronic security system. The security system generally would establish an electromagnetic field in a controlled area through which the article with the security marker must pass when being removed from the controlled premises. An alarm is activated upon passing the article through the electromagnetic field, thereby alerting authorities of the unauthorized removal of the article.

Another type of EAS security system is referred to as a harmonic system because it is based on the principle that a magnetic material (e.g., a magnetomechanical or acoustomagnetic label) passing through a magnetic field having a selected frequency disturbs the field and produces harmonic perturbations of the selected frequency. The magnetic material may itself include a magnetic resonator that mechanically vibrates at a predetermined frequency when within the magnetic field. The detection system is tuned to recognize certain harmonic frequencies (such as the frequency of vibration from the magnetic resonator) which, if present, activate an alarm. Thus, if an article with a security marker that causes a disturbance in the magnetic field passes through such a harmonic system, an alarm or other signal is generated to indicate or to prevent removal of such article from the premises. Other types of harmonic electronic article surveillance systems are based on markers which include a thin strip or wire of magnetic material that responds to an alternating interrogation signal to activate an alarm.

Security markers may be associated with an article in any of a variety of manners. For instance, a security marker may be integrated with a price label attached to an article, or imbedded or incorporated in the packaging for the article, or placed in the article itself. Thus, the security marker may be attached external to the article to be protected, or internal to the product or its packaging. Depending on the article, placement on the exterior of the article may be simpler, particularly since such placement may be performed separately from and after the manufacture of the article.

One disadvantage of the placement of a security marker on the exterior of the article to be protected is that the security marker is susceptible to removal, thus facilitating unauthorized removal of the article from the secured area. An externally positioned security marker is also susceptible to accidental removal, such as by becoming caught on another object. Moreover, removal of an externally placed security marker by an authorized person also may have disadvantages. For instance, the material to which the security marker is attached may become torn or ripped upon removal of the security marker therefrom, thus marring the appearance of the article.

Because security markers may be removed from an article by an individual who intends to remove the article from a given area without authority, it is desirable to associate the security marker with the article such that it is not readily removable from the article. For instance, the security marker may be secured to the article such that it may not easily be removed from the article without damaging the article. Such security markers include tags containing dyes that are released upon unauthorized removal of the tag from the article. Alternatively, or additionally, the security marker may be associated with the article in a manner that conceals the security marker from ready detection. For instance, a security marker may be embedded within a book cover, as disclosed in U.S. Pat. Nos. 6,094,137 and 7,233,246; within a bottle cap, as disclosed in U.S. Pat. No. 6,137,413; or incorporated within a media storage disk box, as disclosed in U.S. Pat. No. 6,619,079. It has also been known to hide a security marker on the bottom of a regular container and to cover the security marker by adding a second container bottom (considered a false bottom) over the security marker. Additional process steps, machinery, and material thus are required by such solution. Moreover, the external dimensions of the container are increased without increasing the volume capacity, and the false bottom is a visual cue for assisting in locating the security marker to remove it.

### SUMMARY OF THE INVENTION

In accordance with the principles of the present invention, an article is formed to receive a security marker in a manner that permits ready concealment of the security marker. Additionally, or alternatively, an article is formed in accordance with the principles of the present invention such that a security marker may be associated therewith such that it does not impact the appearance of the article to an observer, yet removal of the security marker would damage the packaging in a manner that is undesirable to a user of the article and/or readily noticeable by the establishment from which the article is being improperly removed.

The article of the present invention may be formed to permit association of a security marker therewith in a manner that does not add manufacturing or assembly steps or components beyond those normally used.

The security marker and article may be formed and/or arranged such that the security marker is not readily visible to an individual and/or does not protrude. For instance, the security marker may be hidden such that the external appearance of the article is no different from the external appearance of a similar article without a security marker. As such, the security marker is less apt to be intentionally or unintentionally removed from the article.

These and other features and advantages of the present invention will be readily apparent from the following detailed description of the invention, the scope of the invention being set out in the appended claims.

### BRIEF DESCRIPTION OF THE DRAWINGS

The detailed description will be better understood in conjunction with the accompanying drawings, wherein like reference characters represent like elements, as follows:

FIG. 1 is a perspective view of an exemplary article formed to permit a security marker to be associated therewith in a manner that permits concealment of the security marker;

FIG. 2 is a side elevational view of the article of FIG. 1;

FIG. 3 is a perspective view of an exemplary article with a security marker affixed thereto in accordance with the principles of the present invention;

FIG. 4 is a side elevational view of an article, as in FIG. 2, but with a security marker associated with the article and concealed from view; and

FIG. 5 is a perspective view of another exemplary article formed to permit a security marker to be associated therewith in a manner that permits concealment of the security marker.

### DETAILED DESCRIPTION OF THE INVENTION

In accordance with the principles of the present invention, a security marker is provided on article in a manner that deters or prevents removal of the article from a given area. The security marker may be in any desired form, such as an element that is detectable by a sensor at a detection point or zone in the given area. A detection point or zone may be created at every point of entry or exit (“doors” for the sake of convenience, regardless of whether or not an actual door is present to block the entrance or exit of individuals or articles) to the given area. The sensor may be a part of an electronic article surveillance (“EAS”) security system, such security systems being well known in the art. An alarm or other appropriate action may be initiated upon passing the security marker past the detection point in the given area. It will be appreciated that the present invention is not limited to any particular security marker or security system or other detection system.

In accordance with the principles of the present invention, a security marker is provided on the exterior of an article in a manner such that the security marker does not protrude, or at least does not protrude significantly, beyond the external surface of the article. As such, the security marker is not evident to an individual and is less likely to be identified or located for deliberate removal from the article to remove the article from a restricted area without authorization. Moreover, because the security marker does not protrude, or at least does not significantly protrude, beyond the external surface of the article, it is less likely to be inadvertently removed (such as by getting caught on another object).

An exemplary article 100 incorporating the principles of the present invention is illustrated in FIG. 1 in the form of a primary packaging (a packaging directly containing a product). More particularly, exemplary article 100 is in the form of a container, such as a bottle. However, any other type of article can incorporate the principles of the present invention as well, such as a secondary packaging (a packaging containing another packaging, such as a primary packaging, for a product), as described in further detail below.

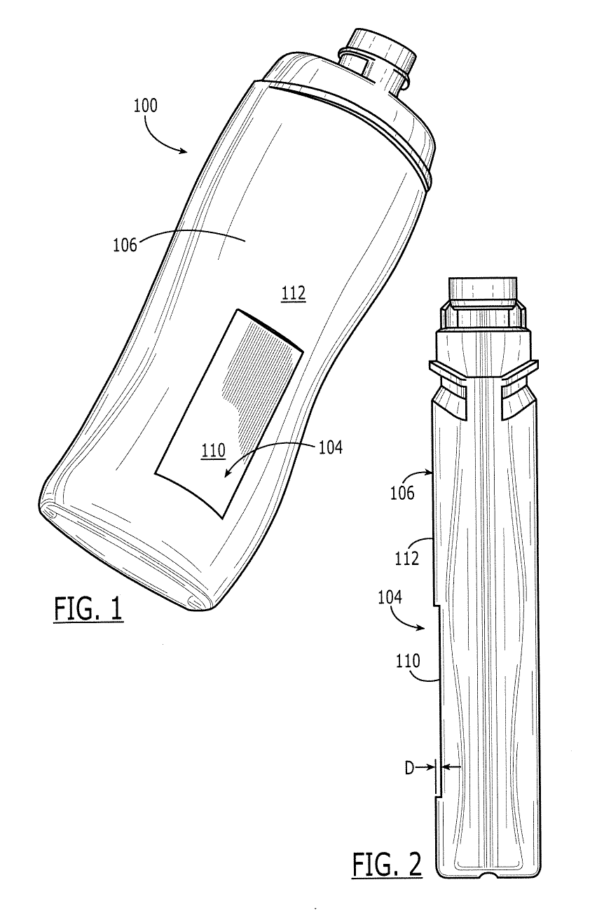

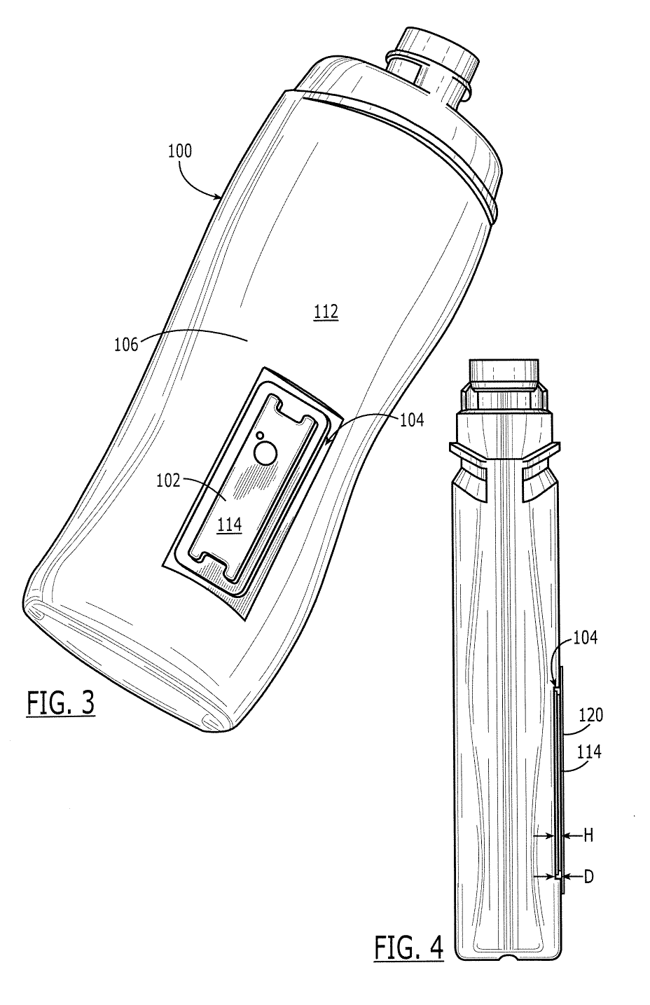

Exemplary article 100 preferably is formed such that a security marker may be associated therewith in a manner that deters removal therefrom. More particularly, article 100 may be shaped, configured, or formed such that a security marker may be associated therewith in a manner that does not allow ready accidental or deliberate removal of the security marker from article 100. For instance, as illustrated in FIGS. 3 and 4, article 100 may be formed to receive a security marker 102 such that security marker 102 does not protrude from and is not otherwise offset from article 100. More particularly, article 100 may be formed with a recessed area 104 configured to receive security marker 102 without allowing security marker 102 to protrude beyond wall 106 in which recessed area 104 is formed. As illustrated in FIGS. 2-4, recessed area 104 may be formed with a depth D (measured from bottom surface 110 of recessed area 104 to exterior surface 112 of wall 106) that is preferably substantially equal to height H of security marker 102, such that top surface 114 of security marker 102 does not extend past exterior surface 112 of wall 106 of article 100, and is not too far below exterior surface 112 of wall 106 to permit a gap between top surface 114 of security marker 102 and a cover 120 applied over security marker 102 (which may result in undesirable effects such as the capture of air bubbles below cover 120, causing expansion or contraction of cover 120 and resultant protuberances or depressions). However, it is within the scope of the invention to form recessed area 104 with a depth D slightly larger than height H of security marker 102, alterations to a cover 120, if used, being possible (such as increasing the thickness of cover 120) to account for the gap between cover 120 and top surface 114 of security marker 102. Thus, depth D of recessed area 104 can be from about 0% to about 50% greater than height

Recessed area 104 may be formed in any desired manner to receive security marker 102 or otherwise to permit association of security marker 102 therewith. For instance, recessed area 104 may be a depression of any shape in plan view (including, without limitation, circular, square, rectangular, or irregular) or cross-sectional view (including, without limitation, square or concave). If wall 106 of article 100 is contoured (e.g., convex or concave), bottom surface 110 of recessed area 104 may or may not follow the contour of external wall 106. If desired, bottom surface 110 of recessed area 104 may be flat to accommodate a typical security marker 102 with a flat bottom surface that is normally associated with an article, regardless of the shape or contour of wall 106 in which recessed area 104 is formed. Although recessed area 104 may be configured to conform to the shape of a particular security marker 102, it will be appreciated that a recessed area 104 larger than the security marker 102 contemplated for placement on article 100 may be formed instead. The provision of an approximately 2 mm gap between the perimeter of security marker 104 and the inner perimeter of recessed area 104 may be desirable to facilitate placement of security marker 102 within recessed area 104, particularly if such placement is accomplished by automated equipment. A generically-shaped, larger-sized recessed area 104 may be preferred so that article 100 need not be changed if the shape or size of security marker 102 is changed. For instance, recessed area 104 may be approximately 0% to approximately 100% larger than the area of security marker 102 or have a perimeter approximately 0% to approximately 100% larger than the perimeter of security marker 102.

Recessed area 104 may be formed in any desired manner in article 100. For instance, if article 100 is formed by extrusion blow-molding or injection stretch blow-molding, the template of the article may simply be modified to create the desired recessed area 104 in the resulting article 100. Similarly, if article 100 is molded, then the mold may be modified to build up an area where recessed area 104 is to be formed, thereby causing the finished molded product to have a recessed area 104. However, it will be appreciated that article 100 may be formed from any desired material, and not necessarily a moldable material. For instance, article 100 may be made of glass or paperboard and formed in any desired manner to have a recessed area 104 in accordance with the principles of the present invention.

A benefit of forming article 100 such that security marker 102 may be associated therewith out protruding therefrom is that security marker 102 may be covered and hidden from view. The cover may be formed of any desired material, such as paper, paperboard, plastic, plastic film, of any desired thickness that would achieve the desired visual effect of the present invention. For instance, as illustrated in FIG. 4, a cover 120 such as a label may be positioned on wall 106 of article 100 over recessed area 104 such that the presence of security marker 102 cannot be readily detected. As such, theft or inadvertent removal of article 100 from a restricted area (such as a retail center) may be deterred because the presence of a security marker is not evident. Thus, an individual intending to remove article 100 from premises with doors equipped with EAS security systems likely will not know a security marker must be removed from the article. The individual thus will not know to remove a security marker from such article before improperly removing the article from the premises, and will actuate the EAS security system upon removal of the article from the premises. Accordingly, a consumer is less likely to be alerted to the need to tamper with article 100 to guarantee ease of unauthorized removal from the premises, and theft of article 100 is more readily prevented than if article 100 were provided with a security marker not formed in accordance with the principles of the present invention. Moreover, if security marker 102 is hidden below a cover 120, then an individual would mar the appearance of article 100 by removing cover 120 to remove security marker 102. Accordingly, an individual is unlikely to remove security marker 102 from article 100 when concealed by a cover 120 for this reason as well.

It will be appreciated that security marker 102 may be coupled to article 100 in any desired manner. For instance, adhesive may be applied on a surface of security marker 102 to facilitate attachment thereof to article 100. Alternatively, if a cover 120 is to be placed over a recessed area 104 in which security marker 102 is placed, cover 120 may maintain security marker 102 within recessed area 104 without the need for an adhesive. Or, security marker 102 may be secured to cover 120 or formed as an integral part of cover 120 such that the securing of label 110 to article 100 results in securing of security maker 102 to article 100 as well. Securing of cover 120 to article 100 may be effected in any desired manner such as, without limitation, through the use of pressure-sensitive adhesive or the like. It will be appreciated that association of security marker 102 and/or cover 120 to article 100 may be effected manually or by machine.

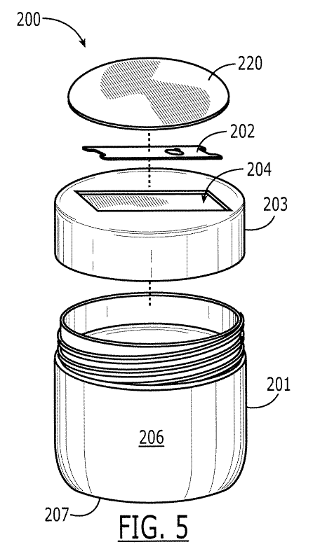

As noted previously, the principles of the present invention may be applied to other types of articles as well. Another exemplary article 200 to which the principles of the present invention may be applied is illustrated in FIG. 5. More particularly, exemplary article 200 is in the form of a container, such as a jar or tub 201, that has a separate cap or lid 203. Security marker 202 may be provided within a recessed area 204 formed within cap 203 and covered with cover 220. It will be appreciated that, as with container 100 of FIGS. 1-4, recessed area 204 may be modified in any desired manner to achieve the desired effect, and security marker 202 may be secured therein in any desired manner to achieve the desired effect. Moreover, it will be appreciated that recessed area 204 may be formed in a side wall 206 or bottom wall 207 of jar 201 instead of in cap 203.

Also as noted previously, the principles of the present invention need not be applied only to a primary packaging. For instance, a secondary packaging may be modified for association with a security marker in accordance with the principles of the present invention. Typical secondary packagings are formed from cardboard, paperboard, plastic (e.g., a clamshell), or a combination thereof (e.g., a blister package) to contain a primary packaging. Preferably, the standard external shape or configuration of the secondary packaging is altered in accordance with the principles of the present invention such that a security marker applied thereto does not protrude from the external surface of the secondary packaging so that the security marker is not readily removed therefrom. Preferably, a cover or other element may be provided over the security marker to conceal its presence, thereby further decreasing the chances that an individual will remove the security marker.

A security marker placed on an article in the manner of the present invention provides the unique benefit that it is not readily visible and/or does not protrude from the article. Accordingly, the article does not lend itself to removal of the security marker therefrom either intentionally (as the location of the security marker is not readily discerned by an individual) or unintentionally (as the security marker does not protrude from the article and thus is not liable to become caught on another element and inadvertently separated from the article). Provision of a security marker in such manner on a consumer article is particularly desirable for manufacturers and/or retailers to reduce the likelihood of theft of the consumer article. Relatively small and/or expensive consumer articles that are more apt to be stolen are especially suited for application of the principles of the present invention thereto.

A further benefit of the present invention is that the security marker is readily placed on the article without requiring additional manipulation of the article or additional, non-standard components to be applied on the article. Materials in addition to those normally used in production and shipping of the article are not required, thus simplifying manufacturing and reducing complexity and costs (both labor and materials costs).

While the foregoing description and drawings represent exemplary embodiments of the present invention, it will be understood that various additions, modifications and substitutions may be made therein without departing from the spirit and scope of the present invention. In particular, it will be clear to those skilled in the art that the present invention may be embodied in other specific forms, structures, arrangements, proportions, and with other elements, materials, and components, without departing from the spirit or essential characteristics thereof. One skilled in the art will appreciate that the invention may be used with many modifications of structure, arrangement, proportions, materials, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being indicated by the appended claims, and not limited to the foregoing description.

What is claimed is:

1. A packaging configured to receive a security marker that actuates a security system upon removal from a predetermined area, said packaging comprising:
a packaging wall having an exterior surface;
a recessed area formed within said exterior surface of said packaging wall and shaped and sized to receive a security marker therein; and
a cover over said recessed area shaped to conceal said recessed area.

2. A packaging as in claim 1, wherein:
said recessed area has a bottom surface and a depth measured from said bottom surface to said exterior surface of said packaging wall; and
said recessed area is shaped and said depth of said recessed area is selected to receive a security marker in said recessed area such that the security marker does not extend past said exterior surface of said packaging wall.

3. A packaging as in claim 2, further comprising a security marker positioned within said recessed area and below said cover.

4. A packaging as in claim 3, wherein said recessed area depth is about 0% to about 50% greater than the height of said security marker.

5. A packaging as in claim 3, wherein said cover is a label.

6. A packaging as in claim 2, wherein said recessed area bottom surface is substantially flat.

7. A packaging as in claim 1, wherein said cover is a label.

8. A packaging as in claim 1, wherein said packaging is a primary packaging.

9. A packaging as in claim 8, wherein said primary packaging is a container.

10. A packaging as in claim 8, wherein said container is a molded container.

11. An article configured to receive a security marker that actuates a security system upon removal from a predetermined area, wherein said article has an exterior surface with an area modified to receive the security marker such that the top surface of the security marker does not extend past said exterior surface of said article.

12. An article as in claim 11, wherein said modified area of said exterior surface of said article is a recessed area shaped and sized to receive a security marker therein.

13. A method of deterring the unauthorized removal of an article from a location, said method comprising:
providing a security marker on the exterior surface of the article such that the top surface of the security marker does not extend beyond the exterior surface of the article.

14. The method of claim 13, further comprising covering the security marker to conceal the security marker.

15. The method of claim 14, wherein covering the security marker comprising applying a label over the security marker to be flush with the exterior surface of the article.

16. The method of claim 13, wherein:
the exterior of the article has a recessed area; and
providing a security marker on the exterior surface of the article comprises providing the security marker in said recessed area.

17. The method of claim 16, further comprising applying a label over the recessed area and the security marker to conceal the security marker.
